(19) United States
(12) Patent Application Publication
(10) Pub. No.: US 2010/0025118 A1
(43) Pub. Date: Feb. 4, 2010

(54) APPARATUS

(75) Inventors: Edward James Hampson, New South Wales (AU); Paul Anthony Williams, Victoria (AU); Tony Lee Braut, Victoria (AU)

Correspondence Address: WESTMAN CHAMPLIN & KELLY, P.A., SUITE 1400, 900 SECOND AVENUE SOUTH, MINNEAPOLIS, MN, 55402, US

(73) Assignee: TPT Precision Engineering Pty Ltd, Wondonga (AU)

(21) Appl. No.: 12/184,481

(22) Filed: Aug. 1, 2008

(51) Int. Cl. E21B 17/07; E21B 17/02; F16D 3/68; F16D 3/50; F16D 3/06

(52) U.S. Cl. 175/321

(57) ABSTRACT

A cushion sub 10 including an input portion 130 for receiving drive from a drive means, and an output portion 60 for transmitting the drive to a drill string. One of the input portion 130 and the output portion 60 including one or more guides 70. The other of the input portion 130 and the output 60 portion being engaged with the one or more guides 70 for transmitting the drive and arranged for relative reciprocating sliding movement along the one or more guides 70 between a first and a second limit of movements. At least one of the one or more guides 70 including a shoulder 500 adjacent at least one of and between the first and the second limit of movement to minimise adverse step formation as the at least one guide 70 wears. One of the input portion 130 and the output portion 60 may define a cylinder 20, 50 including first end wall 40 and second endwall 50. The guides 70 might be formed by drive pins 70. The drive pins 70 may be press fitted to the first endwall 40. The drive pins 70 may be mounted to the second endwall 50 via respective resiliently deformable mountings 310. The drive pins 70 may include a lubricating groove 400.

### FIELD OF THE INVENTION

The invention relates to cushion subs.

### BACKGROUND OF THE INVENTION

Cushion subs are used in mining applications for dampening vibrations transmitted upwardly through the drill string. The cushion sub is positioned between the top of the drill string and the power head and serves to protect the power head from vibrations, for example, vibrations generated by downhole hammering operations.

U.S. Pat. No. 4,192,155 describes a cushion sub for connecting the rotary power head of a drill rig to a drill string. The cushion sub includes an outer housing 24 and a head in the form of cap member 40 which together define a cylinder. A piston in the form of mandrel 12 is received within the cylinder and is axially moveable therein. Guides in the form of axially extending splines 32 are spaced around the internal wall of the housing 24. The mandrel 12 includes axially extending external splines 22 which in use slide along the splines 32. Resilient cushion members 56 and 60 are positioned within the cylinder-like space defined by housing 24 and cap member 40 fore and aft of the mandrel 12. In operation the splines 32, 22 engage for transmitting torque, i.e. rotational drive, and the mandrel 12 may move axially within the housing 24 to compress the cushion members 56, 60 at the extremes of axial motion, thus dampening axial vibration.

Some cushion subs on the market include a piston and cylinder arrangement similar to that of U.S. Pat. No. 4,192,155 and are in use filled with a suitable fluid, such as grease, and configured so that the fluid is displaced by the movement of the piston within the cylinder to provide a dampening affect.

In operation cushion subs wear out. It is an object of the invention to provide a cushion sub having an improved service life, or at least provide an alternative in the market.

It is not admitted that any of the information in this specification is common general knowledge, or that the person skilled in the art could be reasonably expected to have ascertained, understood, regarded it as relevant or combined it in anyway at the priority date.

### SUMMARY OF THE INVENTION

The applicant has discovered that the guides and the mounting of the guides are areas prone to wear. In particular the applicant has discovered that the piston tends to wear the guides along a region corresponding to the usual range of movement of the piston. This results in the formation of a raised step adjacent the limits of movement of the piston. This step is adverse to performance in that whenever the piston moves beyond its usual range of movement, e.g. when the cushion sub is experiencing greater than the usual vibration, the piston strikes the step causing vibration to be transmitted. This of course places limits on the service life of the cushion sub.

Testing has shown that the mounting of the guides within the head is another area where wearing is a problem. Testing of various hardened materials to mount the guides has been found to yield unsatisfactory results. The applicant has discovered, surprisingly, that by using a resiliently deformable mounting the service life of the cushion sub can be improved. This has also been found to reduce vibration transmission from the guides to the head.

In one aspect of the invention there is provided a cushion sub including an input portion for receiving drive from a drive means, and an output portion for transmitting the drive to a drill string;

one of the input portion and the output portion including one or more guides, the other of the input portion and the output portion being engaged with the one or more guides for transmitting the drive and arranged for relative reciprocating sliding movement along the one or more guides between a first and a second limit of movement;

at least one of, and preferably each of, the one or more guides including a shoulder adjacent at least one of and between the first and the second limit of movement to minimise adverse step formation as the at least one guide wears.

The shoulder(s) could be formed by an end face of the guide, and of course may have a rounded profile. The shoulder(s) are preferably formed by relieved guide portions.

The one or more guides preferably each include a shoulder adjacent each of and between the first and the second limit of movement to minimise adverse step formation as the one or more guides wear.

The one or more guides may extend circumferentially about an in use uphole to downhole axis for the cushion sub to dampen rotational vibration and transmit axial drive. Preferably the one or more guides extend in a direction parallel to an axis about which the cushion sub in use rotates for the cushion sub to dampen axial vibration and transmit rotational drive.

Preferably the one of the input portion and the output portion including the one or more guides defines a cylinder, the other of the input and the output portion defining a piston axially slidably housed within the cylinder.

In one embodiment the cylinder and the piston each have a complementary non-circular cross section, in which case internal walls of the cylinder may form the one or more guides. In another embodiment the cylinder includes guides in the form inwardly directed splines cooperable with outwardly directed splines disposed about a periphery of the piston.

Preferably at least one of, and more preferably each of, the one or more guides is formed by a pin, each pin being parallel to the axis and passing through a respective aperture, preferably a respective cylindrical aperture, extending through the other of the input and the output portion. Advantageously the pins may be cylindrical, in which case the relieved guide portion is preferably a cylindrical pin portion of smaller diameter than a main pin portion along which the other of the input portion and the output portion slides.

According to preferred forms of the invention the input portion includes the one or more guides.

In another aspect of the invention there is provided a cushion sub including an input portion for receiving drive from a drive means, and an output portion for transmitting the drive to a drill string;

one of the input portion and the output portion defining a cylinder having a first end wall and a second end wall, the other of the input portion and the output portion defining a piston within the cylinder; and

one or more guide pins within and fixed to the cylinder; the one or more guide pins extending in a direction parallel to an axis about which the cushion sub in use rotates; at least one of, and preferably each of, the one or more guide pins passing through a respective aperture, preferably a respective cylindrical aperture, extending through the piston;

the piston being arranged for axial relative reciprocating sliding movement along the one or more guide pins and engaged with the guide pins for transmitting rotational drive from the input portion to the output portion;

each guide pin having a first end, a second end and a main pin portion along which the piston slides;

wherein the first end, and preferably only the first end, of at least one of, and preferably each of, the guide pins is press fitted into the first end wall of the cylinder.

The pins are preferably cylindrical. The press fit preferably includes an interference of about 50 μm, say 50±20 μm, on diameter is preferred.

The first end of the at least one, or preferably each, guide pin is preferably of smaller diameter than the main pin portion. The best results are obtained when the first end is ‘straight’ i.e. not tapered.

Preferably the second end of the at least one, or preferably each, guide pin is mounted to the second end wall via a mounting, the mounting being formed of resiliently deformable material for absorbing vibrations. The mounting is preferably fitted over and surrounds the second end and is fitted within a respective recess in the second end wall. Preferably the mounting is press fitted to the second end. The mounting is preferably a tubular sleeve having open ends.

The second end of the at least one, or preferably each, guide pin is preferably of smaller diameter than the main pin portion. The mounting may have an outer diameter substantially equal to the diameter of the main pin portion.

The mounting is preferably formed of urethane.

In another aspect of the invention there is provided a cushion sub including an input portion for receiving drive from a drive means, and an output portion for transmitting the drive to a drill string; and

one of the input portion and the output portion defining a cylinder having a first endwall and a second endwall, the other of the input portion and the output portion defining a piston within the cylinder;

one or more guide pins within and fixed to the cylinder; the one or more guide pins extending in a direction parallel to an axis about which the cushion sub in use rotates; at least one of, and preferably each of, the one or more guide pins passing through a respective aperture, preferably a respective cylindrical aperture, extending through the piston;

the piston being arranged for axial relative reciprocating sliding movement along the one or more guide pins and engaged with the guide pins for transmitting rotational drive from the input portion to the output portion;

each guide pin having a first end, a second end and a main pin portion along which the piston slides;

wherein the second end of at least one, or preferably each, guide pin is fixed to the second endwall via a respective mounting, each mounting being formed of resiliently deformable material for absorbing vibrations.

In another aspect of the invention there is provided a cushion sub including an input portion for receiving drive from a drive means, and an output portion for transmitting the drive to a drill string;

one of the input portion and the output portion defining a cylinder having a first endwall and a second endwall, the other of the input portion and the output portion defining a piston within the cylinder;

one or more guide pins within and fixed to the cylinder, the one or more guide pins extending in a direction parallel to an axis about which the cushion sub in use rotates; at least one of, and preferably each of the one or more guide pins passing through a respective aperture, preferably a respective tubular aperture, within the piston;

the piston being arranged for axial relative reciprocating sliding movement along the one or more guide pins and engaged with the guide pins for transmitting rotational drive from the input portion to the output portion;

each guide pin having a first end, a second end and a main pin portion along which the piston slides;

at least one of, or preferably each of, the one or more guide pins including a lubricating groove along its main pin portion.

The groove may be helical, and preferably extends substantially the full length of the main pin portion.

The various aspects of the invention are complementary; each aspect may incorporate the features of the other aspects of the invention.

### BRIEF DESCRIPTION OF THE DRAWINGS

FIG. 1 is a schematic axial cross-sectional view of a cushion sub according to a preferred form of the invention;

FIG. 2 is a top end view of the piston of the cushion sub of FIG. 1;

FIG. 3 is an axial cross-sectional view of the piston of FIG. 2;

FIG. 4 is a bottom end view of the head of the cushion sub of FIG. 1;

FIG. 5 is an axial cross-sectional view of the head of FIG. 4;

FIG. 6 is a bottom end view of the cylinder of the cushion sub of FIG. 1;

FIG. 7 is an axial cross-sectional view of the cylinder of FIG. 6;

FIG. 8 is a top end view of the cylinder of FIG. 6;

FIG. 9 is a side view of the air nozzle of the cushion sub of FIG. 1; and

FIG. 10 is a side view of one of the drive pins of the cushion sub of FIG. 1.

### DETAILED DESCRIPTION OF THE EMBODIMENTS

The cushion sub 10 includes two principal components: an input portion 130 and a piston 60. The input portion 130 includes an axially extending conical portion 270 with external threads 80 for receiving a rotational drive from a drill rig power head (not shown). Piston 60 includes an internally threaded tapered section 90 for receiving, and thereby transmitting drive to, a drill string (not shown) and thereby forms an output portion. As described in more detail below a passageway, partly defined by an air nozzle 120, axially extends through the cushion sub 10 for conveying air downhole.

The input portion 130 includes a cylinder body 20 and a head 50 which together define cylinder cavity 140. The cylinder body 20 is made up of a cylinder wall 30 and a back head 40. The piston 60 is axially slideable within the cylinder cavity 140. The input portion 130 also includes a circular array of twelve longitudinal drive pins 70 within the cylinder cavity 140. The drive pins 70 are equi-spaced on a concentrically aligned pitch circle. As described in more detail below, the drive pins 70 are connected at end portions 240, 320 to the back head 40 and to the head 50 respectively.

The piston 60 includes a squat cylindrical head portion 190 and an integrally formed tubular stem like body portion 180. A circular array of guide apertures 150 complementary to the drive pins 70 extends through the head portion 190 of the piston 60. An interior of the body portion 180 includes threaded tapered section 90 at a location distal to the head portion 190. Internally threaded blind bores 510 are provided on an end face of the head portion 190 and provide attachment points to lift and manoeuvre the piston 60 during assembly.

The guide apertures 150 in use slidingly engage the drive pins 70. Torque transmitted from the power head to the input portion 130 (via the tapered thread 80) is transmitted to the piston 60 via the drive pins 70, and the guide apertures 150. Torque is in turn transmitted to the drill string via the tapered thread 90. The piston 60 is in use free to slide along the drive pins 70. In operation the cylinder cavity 140 is packed with grease, although the person skilled in the art will appreciate that other fluids may be suitable. The grease serves a dual role both as a lubricating fluid and as a dampening fluid. The grease serves to lubricate the sliding contacts between the guide pins 70 and the guiding apertures 150. As the cylinder 60 moves axially within the cylinder cavity 140 the grease is displaced through small clearances between the drive pins 70 and the guide apertures 150 and between the cylinder 60 and the internal dimension of the cylinder wall 30. In this embodiment a radial clearance of about 0.25 mm is provided about the periphery of the cylinder 60. The viscous action of the grease being forced through these small clearances serves to dampen axial vibration.

Resilient cushion members 100, 110 are provided within the cylinder cavity 140 at respective ends of the piston stroke to provide further dampening. As the piston 60 approaches either end of the cylinder cavity 140 the respective cushion member 100, 110 compresses to provide a soft end to the piston stroke. The compressed state of the cushion members 100, 110 thereby defines the limits of movement of the piston 60.

Each of the cushion members 100, 110 have a circular shape corresponding to the interior of the cylindrical wall 30 and include circular apertures to accommodate the drive pins 70. Cushion member 100 includes a large central circular aperture to accommodate the body 180 of the piston 60. Cushion member 110 includes a central aperture to accommodate the air nozzle 120.

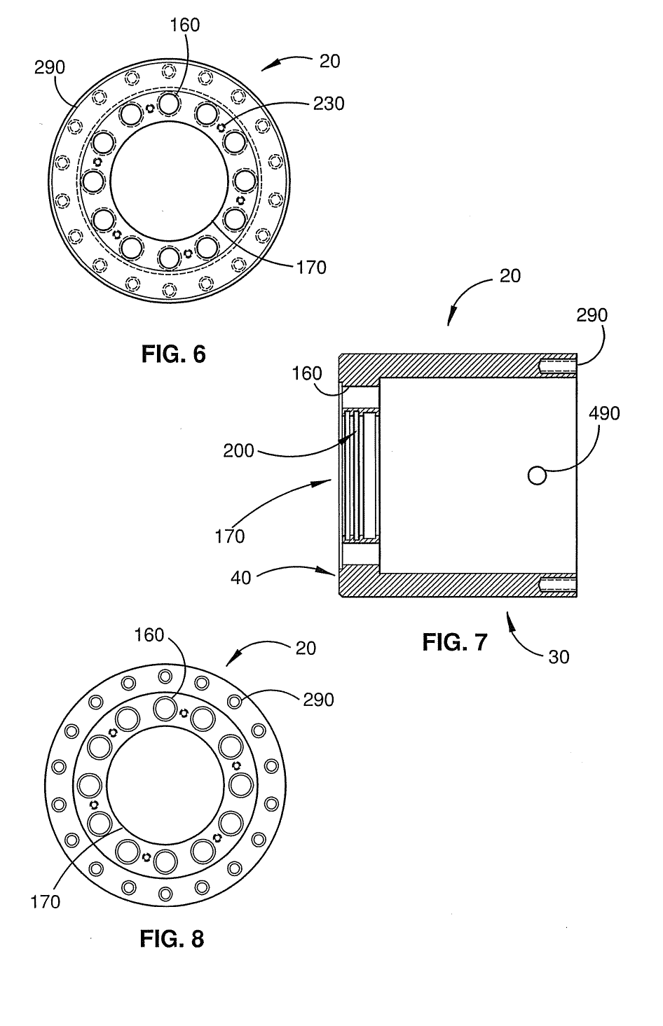

FIGS. 6, 7 and 8 illustrate the cylinder body 20 in more detail. In this embodiment the cylinder body 20 is integrally formed and includes the cylinder wall 30 and the back head of 40. The cylinder wall 30 has a cylindrically tubular cross section. One end of the cylinder wall 30 is spanned by the back head 40. The other end of the cylinder wall 30 is open and is in use closed by the head 50. The back head 40 is a disc-like formation including a large central tubular aperture 170, through which in operation the cylinder body 180 passes, and twelve pin mounting apertures 160 equi-spaced about a concentric pitch circle for receiving the drive pins 70.

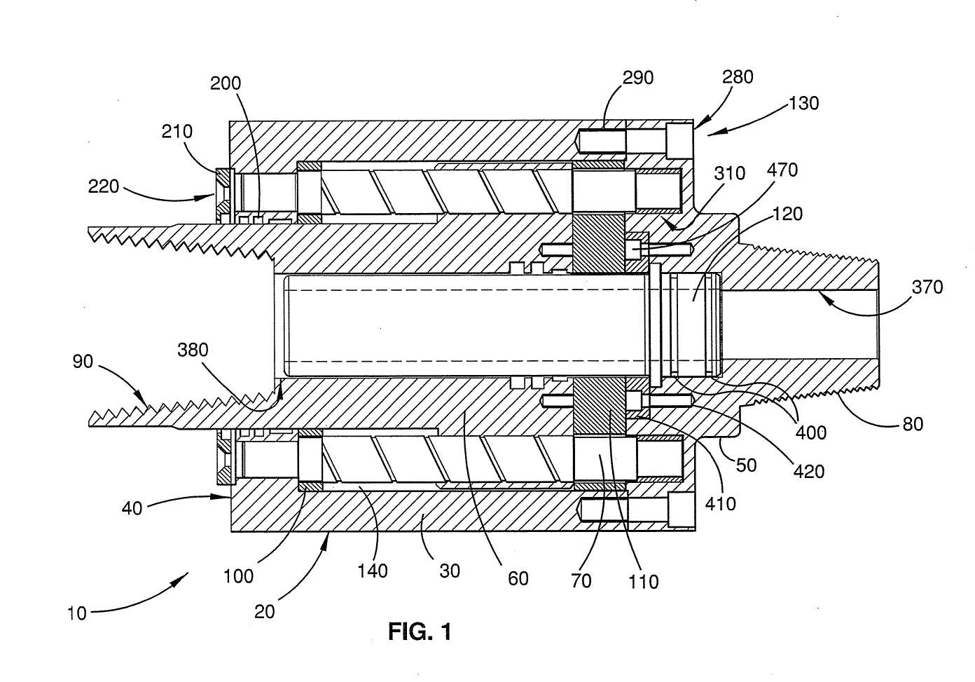

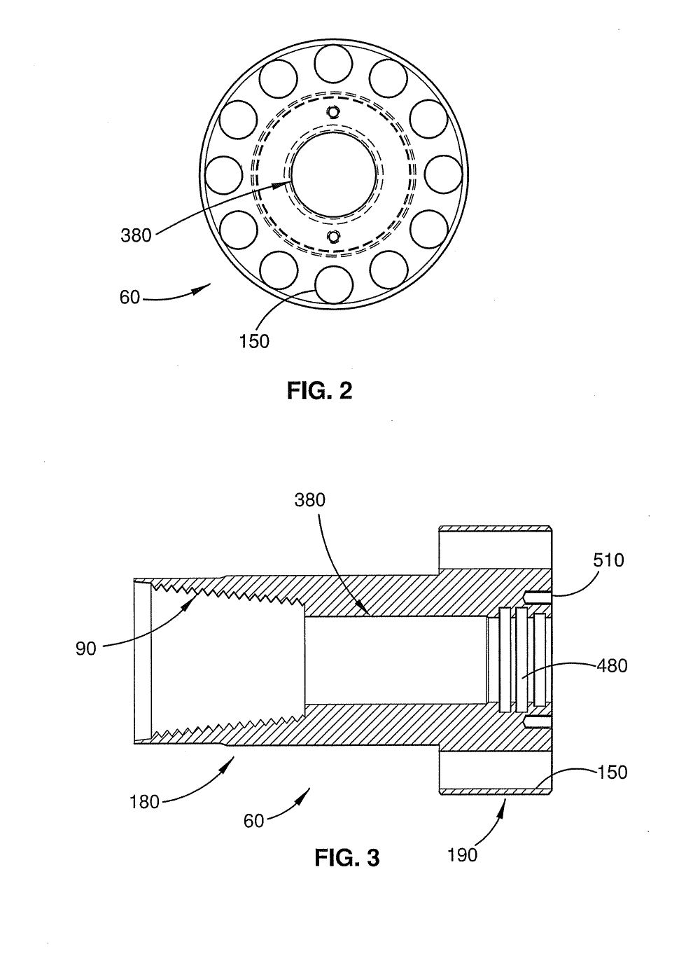

The aperture 170 includes seal mounting structures 200 in the form of inwardly open circumferential grooves. In use seals (not shown) are mounted within the seal mounting structures 200 to create a seal between the piston body portion 180 and the aperture 170 to prevent grease from escaping from the cylinder cavity 140 and to prevent dust and debris contaminating the cylinder cavity 140. Additional sealing is provided by another seal (not shown) retained by the locking ring 210. The locking ring 210 has an annular shape and includes 6 counter sunk bolting apertures 220 equi-spaced about its perimeter. The bolting apertures 220 in use align with complementary threaded bores 230 (shown in FIG. 6) equi-spaced about the back head 40. The locking ring 210 is in use retained by counter-sunk bolts passing through the bolt holes 220 and engaging with the threaded bores 230 to compress the seal (not shown) in place. Note: FIG. 1 shows the locking ring 210 rotated from its usual position to illustrate the bolting apertures 220.

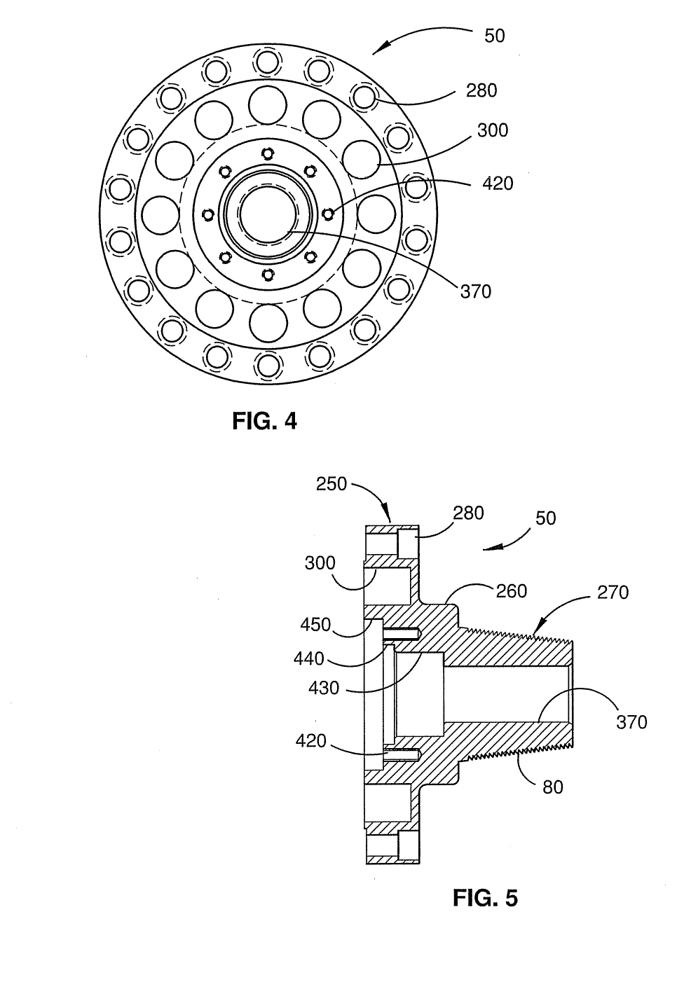

The head 50 includes a disc-like portion of 250 (see FIGS. 4 and 5) which in use closes the open end of the cylinder body 20; a concentric circular boss 260 and the conical portion 270 (which includes the external threads 80).

Twenty axially extending counter-bored bolt holes 280 are equi-spaced about the periphery of the disc-like portion 250 of the head 50. As illustrated in FIGS. 6, 7 and 8 the cylindrical body 20 includes twenty threaded blind bores 290 equi-spaced about an end face of the cylindrical wall 30 at locations complementary to the locations of the bolt holes 280. The head 50 is in use retained relative to the cylinder body 20 by bolts (not shown) passing through the bolt holes 280 and engaging with the threaded bores 290.

Twelve blind bores 300 are equi-spaced on a concentric pitch circle to in-use open into the cylinder cavity 140. As described in more detail below the blind bores 300 are dimensioned to receive a respective sleeve 310 and drive pin end portion 320.

FIG. 10 illustrates a preferred form of drive pin 70. Drive pin 70 includes a main pin portion 330 which in this embodiment has a diameter of 40 mm. The pin 70 includes end portions 320 and 240 which are stepped down to smaller diameters for mounting in the bores 300 of head 50 and apertures 160 of back head 40 respectively. The pin 70 includes relieved portions 340, 350 intermediate the main pin portion 330 and the end portions 240, 320 respectively. Shoulders 500 are formed at the junctures of the main pin portion 330 and the portions 240, 320 respectively.

The pin mounting apertures 160 of back head 40 are straight cylindrical bores extending in an axial direction through the back head 40. The drive pin end portions 240 are dimensioned for a press fit within a respective one of the apertures 160. In this embodiment the end portion 240 has a nominal diameter of 32 mm. The tolerances on the diameters of the apertures 160 and the end portions 240 are selected for an interference of 50±20 μm. A temperature difference may be used to aid in the assembly of drive pins 70 and back head 40. For example, the drive pins 70 may be cooled by immersion in liquid nitrogen or by packing in dry ice prior to pressing into the apertures 160.

In this embodiment a soft mounting in the form of a sleeve 310 embraces an end portion 320 of each respective drive pin 70. The end portion 320 and the sleeve 310 are in turn mounted with the blind bore 300 of the head 50. The sleeve 310 is formed of urethane, although of course a range of other resiliently deformable materials would be suitable, and provides a degree of cushioning between the head 50 and the drive pin 70 which has been found to provide an improved service life. Preferably, as illustrated, the end portion 320 has a lesser diameter than the main portion 330 of the pin 70. This advantageously allows for a relatively thick sleeve 310 to be used without increasing the size of the blind bore 300 (which would involve changing the layout of the cushion sub 10, including expanding the overall diameter of the cushion sub 10).

In this embodiment the end portion 320 has a diameter of 32 mm. The sleeve 310 has a nominal internal diameter of 31 mm and an outer diameter of 40 mm. The bore 300 has a diameter of 40 mm. During assembly the sleeves 310 are first fitted within the bores 300. The end portions 320 of drive pins 70 are then pressed into the sleeves 310. Thus, there is a 1 mm interference on diameter between the sleeve 310 and end portion 320 so that the sleeve 310 is expanded and compressed in place. This mounting arrangement has been found to locate the drive pins 70 with sufficient accuracy, to reduce wear, and to minimise vibration transmission from the drive pins 70 to the head 50 and thereby minimise vibration transmission to the drill rig power head.

In this embodiment the relieved portions 340, 350 are cylindrical and have a diameter of 38 mm (the main pin portion 330 has a diameter of 40 mm) so that there is a 1 mm set back at shoulder 500. In use the piston 60 slides along the main portion 330 of the drive pin 70. Over time this sliding motion in conjunction with the torque being transmitted wears an axially extending side region of the drive pin 70. This embodiment allows for a full millimetre of wear on the drive pins before an adverse step starts to form. This greatly improves the service life of the cushion sub 10.

Another improvement directed to the problem of the main portion 330 of the pin 70 wearing is the provision of a lubricating groove in the form of helical scroll 360. In this embodiment, the scroll 360 is a single groove helically extending the full length of the main portion 330. The scroll 360 is 4 mm wide, 0.5 mm deep and has a pitch of 48 mm. The groove has been found to be effective at carrying lubrication to the wearing portions of the main portion 330.

The head 50 includes a central axial passageway 370 which is in use communicated with a central axial passageway 380 extending through the piston 50. These intercommunicating passageways provide means for the drilling head to fluidly communicate with the drill string. By way of example a charge of pressurised air, say at about 500 psi, can be provided from the drill rig power head to the drill string via the cushion sub to create an upward flow of air in the annular space downhole about the drill string. Dust entrained in this airflow provides information about the rock at the lower extent of the drill string.

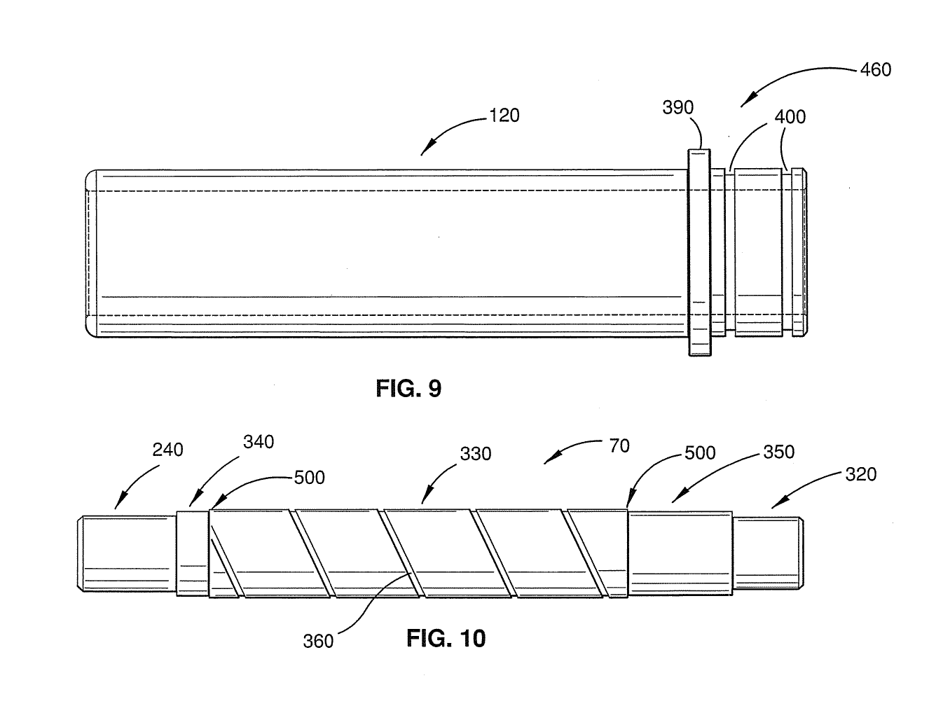

FIG. 9 depicts air nozzle 120 that is a cylindrical tubular structure and towards one end includes an outwardly extending peripheral flange 390 and between the flange and the end two outwardly open circumferential grooves 400.

As illustrated in FIG. 1 the air nozzle 120 is in use fixed relative to the head 50. For this purpose the head 50 includes concentric countersunk bore portions 430, 440 and 450 of successively greater diameter (see FIG. 5). As illustrated the bore portion 430 is concentric with the head 50 and sized to receive the end portion 460 of the air nozzle 120. Bore portion 440 is sized to receive the flange 390, and bore portion 450 is in turn sized to receive a lock ring 410. In use the air nozzle 120 is received within the head 50 and the lock ring 410 positioned within the bore 450 to overly the flange 390. The lock ring 410 has an annular form and includes six counter-bored bolt holes 470 equi-spaced on a concentric pitch circle. The lock ring 410 is retained by flush mounted bolts passing through the counter-bored bolt holes 470 and engaging with the threaded blind bores 420 (see FIGS. 4 and 5). In use seals are mounted within the grooves 400 and sealingly connect the air nozzle 120 and the head 50 to prevent pressurised air escaping from the passageway 370.

In use the air nozzle 120 projects into the passageway 380 of the piston 50. As shown in FIG. 3 the piston 50 includes inwardly open circumferential grooves 480 with the passageway 380. In use seals are mounted within the grooves 480 to sealingly, and slidingly, connect the air nozzle 120 and the piston 50. This arrangement allows for the piston 50 to slide axially along the body of the air nozzle 120 and to prevent air leaking from the passageway 380 into the cylinder cavity 140.

As shown in FIG. 7 a radially extending threaded bore 490 passes through the cylindrical wall 30 and provides an inlet port for supplying grease to the cylinder cavity 140. In use a bolt (not shown) sealingly closes the bore 490.

It will be understood that the invention disclosed and defined in this specification extends to all alternative combinations of two or more of the individual features mentioned or evident from the text or drawings. All of these different combinations constitute various alternative aspects of the invention.

1. A cushion sub including an input portion for receiving drive from a drive means, and an output portion for transmitting the drive to a drill string;
one of the input portion and the output portion including one or more guides, the other of the input portion and the output portion being engaged with the one or more guides for transmitting the drive and arranged for relative reciprocating sliding movement along the one or more guides between a first and a second limit of movement;
at least one of the one or more guides including a shoulder adjacent at least one of and between the first and the second limit of movement to minimise adverse step formation as the at least one guide wears.

2. The cushion sub of claim 1 wherein each of the one or more guides includes a shoulder adjacent at least one of and between the first and second limit of movement to minimise adverse step formation as the one or more guides wear.

3. The cushion sub of claim 2 wherein the one or more guides each include a shoulder adjacent each of the first and the second limit of movement, the shoulders being between the first and the second limit of movement, to minimise adverse step formation as the one or more guides wear.

4. The cushion sub of claim 1 wherein the shoulder(s) are formed by relieved guide portions.

5. The cushion sub of claim 1 wherein the one or more guides extend in a direction parallel to an axis about which the cushion sub in use rotates for the cushion sub to dampen axial vibration and transmit rotational drive.

6. The cushion sub of claim 5 wherein the one of the input portion and the output portion including the one or more guides defines a cylinder, the other of the input and the output portion defining a piston axially slidably housed within the cylinder.

7. The cushion sub of claim 5 wherein at least one of the one or more guides is formed by a guide pin, each guide pin being parallel to the axis and passing through a respective aperture extending through the other of the input and the output portion; each pin having a first end, a second end and a main pin portion along which the other of the input portion and the output portion slides.

8. The cushion sub of claim 5 wherein each of the one or more guides is formed by a guide pin, each guide pin being parallel to the axis and passing through a respective aperture extending through the other of the input and the output portion; each pin having a first end, a second end and a main pin portion along which the other of the input portion and the output portion slides.

9. The cushion sub of claim 7 wherein each respective aperture is cylindrical.

10. The cushion sub of claim 7 wherein the guide pin(s) are cylindrical.

11. The cushion sub of claim 10 wherein the shoulder(s) are formed by cylindrical pin portions of smaller diameter than the main pin portion.

12. The cushion sub of any one of claim 7 wherein the first end of each guide pin is press fitted into a first end wall of the one of the input portion and the output portion including the one or more guides.

13. The cushion sub of claim 12 wherein only the first end of each guide pin is press fitted into the first end wall of the cylinder.

14. The cushion sub of claim 12 each press fit includes an interference of 50±20 μm on diameter.

15. The cushion sub of claim 12 wherein the first end of each guide pin is of a smaller diameter than the main pin portion.

16. The cushion sub of claim 12 wherein the first end is not tapered.

17. The cushion sub of claim 7 wherein the second end of each guide pin is mounted to the second end wall via a mounting, the mounting being formed of resiliently deformable material for absorbing vibrations.

18. The cushion sub of claim 17 wherein the mounting is fitted over and surrounds the second end and is fitted within a respective recess in a second end wall of the one of the input portion and the output portion including the one or more guides.

19. The cushion sub of claim 18 wherein the mounting is press fitted to the second end.

20. The cushion sub of claim 18 wherein the mounting is a tubular sleeve having open ends.

21. The cushion sub of claim 18 wherein the second end of each guide pin is of smaller diameter than the main pin portion.

22. The cushion sub of claim 21 wherein the mounting has an outer diameter substantially equal to the diameter of the main pin portion.

23. The cushion sub of claim 17 wherein the mounting is formed of urethane.

24. The cushion sub of claim 7 wherein each of the one or more guide pins includes a lubricating groove along its main pin portion.

25. The cushion sub of claim 24 wherein the groove is helical.

26. The cushion sub of claim 1 wherein the input portion includes the one or more guides.

27. A cushion sub including an input portion for receiving drive from a drive means, and an output portion for transmitting the drive to a drill string;
one of the input portion and the output portion defining a cylinder having a first end wall and a second end wall, the other of the input portion and the output portion defining a piston within the cylinder; and
one or more guide pins within and fixed to the cylinder; the one or more guide pins extending in a direction parallel to an axis about which the cushion sub in use rotates; each of the one or more guide pins passing through a respective aperture extending through the piston;
the piston being arranged for axial relative reciprocating sliding movement along the one or more guide pins and engaged with the guide pins for transmitting rotational drive from the input portion to the output portion;
each guide pin having a first end, a second end and a main pin portion along which the piston slides;
wherein the first end of at least one of the guide pins is press fitted into the first end wall of the cylinder.

28. The cushion sub of claim 27 wherein each respective aperture is cylindrical.

29. The cushion sub of claim 27 wherein the first end of each guide pin is press fitted into the first end wall of the cylinder.

30. The cushion sub of claim 29 wherein only the first end of each respective guide pin is press fitted.

31. The cushion sub of any one of claims 27 wherein the guide pins are cylindrical.

32. The cushion sub of any one of claims 27 wherein the press fits include an interference of 50±20 μm on diameter.

33. The cushion sub of claim 27 wherein the first end of each guide pin is of smaller diameter than the main pin portion.

34. The cushion sub of claim 27 wherein the first end of each guide pin is not tapered.

35. The cushion sub claim 27 wherein the second end of each guide pin is mounted to the second end wall via a mounting, the mounting being formed of resiliently deformable material for absorbing vibrations.

36. The cushion sub of claim 35 wherein the mounting is fitted over and surrounds the second end and is fitted within a respective recess in the second end wall.

37. The cushion sub of claim 36 wherein the mounting is a tubular sleeve having open ends.

38. The cushion sub of claim 35 wherein the second end of each guide pin is of smaller diameter than the main pin portion.

39. The cushion sub of claim 38 wherein the mounting has an outer diameter substantially equal to the diameter of the main pin portion.

40. The cushion sub of claim 27 wherein the mounting is formed of urethane.

41. The cushion sub of claim 27 wherein each of the guide pins includes a lubricating groove along its main pin portion.

42. The cushion sub of claim 41 wherein the groove is helical.

43. The cushion sub of claim 27 wherein the input portion defines the cylinder.

44. A cushion sub including an input portion for receiving drive from a drive means, and an output portion for transmitting the drive to a drill string;
one of the input portion and the output portion defining a cylinder having a first end wall and a second end wall, the other of the input portion and the output portion defining a piston within the cylinder; and
one or more guide pins within and fixed to the cylinder; the one or more guide pins extending in an axial direction; each of the one or more guide pins passing through a respective aperture extending through the piston;
the piston being arranged for axial relative reciprocating sliding movement along the one or more guide pins and engaged with the guide pins for transmitting rotational drive from the input portion to the output portion;
each guide pin having a first end, a second end and a main pin portion along which the piston slides;
wherein the second end of at least one guide pin is fixed to the second endwall via a respective mounting, each mounting being formed of resiliently deformable material for absorbing vibrations.

45. The cushion sub of claim 44 wherein each respective aperture is cylindrical.

46. The cushion sub of claim 44 wherein the end second of each guide pin is mounted to the second end wall via a respective mounting, each mounting being formed of resiliently deformable material for absorbing vibration.

47. The cushion sub of claim 44 wherein each mounting is fitted over and surrounds the second end and is fitted within a respective recess in the second end wall.

48. The cushion sub of claim 47 wherein the sleeve is press fitted to the second end.

49. The cushion sub of claim 47 wherein the mounting is a tubular sleeve having open ends.

50. The cushion sub of claim 44 wherein the second end of each guide pin is of smaller diameter than the main pin portion.

51. The cushion sub of claim 50 wherein the mounting has an outer diameter substantially equal to the diameter of the main pin portion.

52. The cushion sub of claim 44 wherein the mounting is formed of urethane.

53. The cushion sub of claim 44 wherein each of the guide pins includes a lubricating groove along its main pin portion.

54. The cushion sub of claim 53 wherein the groove is helical.

55. The cushion sub of claim 44 wherein the input portion defines the cylinder.

56. A cushion sub including an input portion for receiving drive from a drive means, and an output portion for transmitting the drive to a drill string;
one of the input portion and the output portion defining a cylinder having a first endwall and a second endwall, the other of the input portion and the output portion defining a piston within the cylinder;
one or more guide pins within and fixed to the cylinder, the one or more guide pins extending in a direction parallel to an axis about which the cushion sub in use rotates;
each of the one or more guide pins passing through a respective aperture within the piston;
the piston being arranged for axial relative reciprocating sliding movement along the one or more guide pins and engaged with the guide pins for transmitting rotational drive from the input portion to the output portion;
each guide pin having a first end, a second end and a main pin portion along which the piston slides;
at least one of the one or more guide pins including a lubricating groove along its main pin portion.

57. The cushion sub of claim 56 wherein each respective aperture is cylindrical.

58. The cushion sub of claim 56 wherein each of one or more guide pins includes a lubricating groove along its main pin portion.

59. The cushion sub of claim 56 wherein each respective groove is helical.

60. The cushion sub of claim 56 wherein the groove(s) extend substantially the full length of each respective main pin portion.

61. The cushion sub of claim 56 wherein the input portion defines the cylinder.
